(19) United States
(12) Patent Application Publication
(10) Pub. No.: US 2016/0071211 A1
(43) Pub. Date: Mar. 10, 2016

(54) NONPARAMETRIC TRACKING AND FORECASTING OF MULTIVARIATE DATA

(71) Applicant: International Business Machines Corporation, Armonk, NY (US)

(72) Inventors: Aleksandr Y. Aravkin, Bronx, NY (US); Dmitry M. Malioutov, Tarrytown, NY (US); Kush R. Varshney, Ossining, NY (US)

(21) Appl. No.: 14/480,704

(22) Filed: Sep. 9, 2014

(51) Int. Cl. G06Q 40/06

(52) U.S. Cl. CPC G06Q 40/06

(57) ABSTRACT

Risk management is facilitated by tracking and forecasting multivariate data using nonparametric statistical procedures. Enhanced matrix factorization is used for developing a nonparametric tracking and forecasting algorithm, based on Kalman smoothing, that applies a state space model to both (i) factor loading, and (ii) factor time series of multivariate data in the matrix factorization. One example of use is tracking and forecasting financial risk according to a yield curve based on multivariate financial data. The forecasted yield curve change forms the bases, for example, of risk exposure adjustments associated with US Treasury bond investment.

### STATEMENT ON PRIOR DISCLOSURES BY AN INVENTOR

The following disclosure(s) are submitted under 35 U.S.C. 102(b)(1)(A) as prior disclosures by, or on behalf of, a sole inventor of the present application or a joint inventor of the present application:

(i) Dynamic factor modeling via robust subspace tracking, prepared/presented by Aleksandr Aravkin, Kush Varshney, and Dmitry Malioutov, made publicly available Sep. 24, 2013.

### BACKGROUND OF THE INVENTION

The present invention relates generally to the field of risk assessment, and more particularly to tracking multivariate data.

“Parametric” and “nonparametric” are two broad classifications of statistical procedures. Nonparametric statistical procedures are not based on parameters such as the mean, variance, standard deviations, and proportions. Unlike parametric statistical procedures, nonparametric statistical procedures make no, or few, assumptions about the probability distributions of the variables being assessed. That is, nonparametric statistics generally do not rely on assumptions about the shape or form of the probability distribution from which the data is drawn.

Business analytics is often applied in the financial services sector to help clients quantify, manage, and optimize risk exposure across a range of financial risk domains, including: (i) market; (ii) liquidity; (iii) credit; (iv) operational; (v) insurance; (vi) economic; and (vii) regulatory capital. A yield curve, also referred to as an interest rate curve, and a term-rate curve, shows several yields, or interest rates, across different contract lengths for a similar debt contract. The yield curve shows, for a given borrower, the relation between the interest rate (cost of borrowing) and the time to maturity, known as the “term,” of the debt. Yield curves are important in both finance and risk management decision-making because they show yield percentage across different maturity terms for debt contracts (e.g. bonds). The most frequently reported yield curve compares three-month, two-year, five-year, and thirty-year U.S. Treasury debts. This exemplary yield curve is used as a benchmark for other debt in the market domain, such as mortgage rates and bank lending rates. The yield curve is also used to predict changes in economic output and growth. In summary, financial risk arises from changes in the yield curve.

Yield curve risk is the risk of experiencing an adverse shift in market interest rates associated with investing in a fixed income instrument. The yield curve risk is associated with either a flattening or steepening of the yield curve, which is a result of changing yields among comparable bonds with different maturities. A change in market yield impacts the price of a fixed-income instrument. That is, when market interest rates, or yields, increase, the price of a bond will decrease and vice versa.

Factor models have been used in the finance field to “summarize” the complexity of the full investment universe by finding key drivers and explaining sensitivities of all the instruments to these drivers. Statistical factor models attempt to discover key drivers automatically from historical samples. Factor models are popular for interest rate and general term-rate curves, as well as for equities.

“Kalman filtering” (also referred to as “Kalman smoothing”) generally refers to inference methods for time series data. The original Kalman filter is an algorithm that uses a time series data set of noisy, linear measurements to infer an unknown time series data set that evolves according to a given linear model. Variants and/or extensions of Kalman filters and smoothers are used in various technologies, including: (i) navigation systems (planes, space, robots, and unmanned aerial vehicles); (ii) 3D model reconstruction; (iii) climate and/or weather models; (iv) pharmacokinetic/pharmacodynamic (PK/PD) modeling; and (v) finance for trend filtering. In engineering, a state space representation is a mathematical model of a physical system as a set of input, output, and state variables related by first-order differential equations, or difference equations. To abstract from the number of inputs, outputs, and states, the variables are expressed as vectors. Additionally, if the dynamical system is linear and time invariant, the differential/difference and algebraic equations may be written in matrix form.

### SUMMARY

According to an aspect of the present invention, there is a method, computer program product, and/or system for financial forecasting that performs the following steps (not necessarily in the following order): (i) receiving a set of financial data including a first yield curve; (ii) applying dynamic matrix factorization with Kalman filtering; (iii) learning a model for characterizing the set of financial data; (iv) forecasting a first change to the first yield curve based on the model; and (v) reporting a risk exposure adjustment based, at least in part, on the forecasted first change to the first yield curve.

### BRIEF DESCRIPTION OF THE DRAWINGS

FIG. 1 depicts a cloud computing node used in a first embodiment of a system according to the present invention;

FIG. 2 depicts an embodiment of a cloud computing environment (also called the “first embodiment system”) according to the present invention;

FIG. 3 depicts abstraction model layers used in the first embodiment system;

FIG. 4 is a flowchart showing a first embodiment method performed, at least in part, by the first embodiment system;

FIG. 5 is a block diagram view of a machine logic (for example, software) portion of the first embodiment system;

FIG. 6 is a screenshot view showing information that is generated by and/or helpful in understanding embodiments of the present invention; and

FIG. 7 is a diagram view showing information that is generated by and/or helpful in understanding embodiments of the present invention.

### DETAILED DESCRIPTION

Risk management is facilitated by tracking and forecasting multivariate data using nonparametric statistical procedures. Enhanced matrix factorization is used for developing a nonparametric tracking and forecasting algorithm, based on Kalman smoothing, that applies a state space model to both (i) factor loading, and (ii) factor time series of multivariate data in the matrix factorization. One example of use is tracking and forecasting financial risk according to a yield curve based on multivariate financial data. The forecasted yield curve change forms the bases, for example, of risk exposure adjustments associated with US Treasury bond investment. This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources, but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for loadbalancing between clouds).

A cloud computing environment is service oriented with a focus on statelessness, low coupling, modularity, and semantic interoperability. At the heart of cloud computing is an infrastructure comprising a network of interconnected nodes.

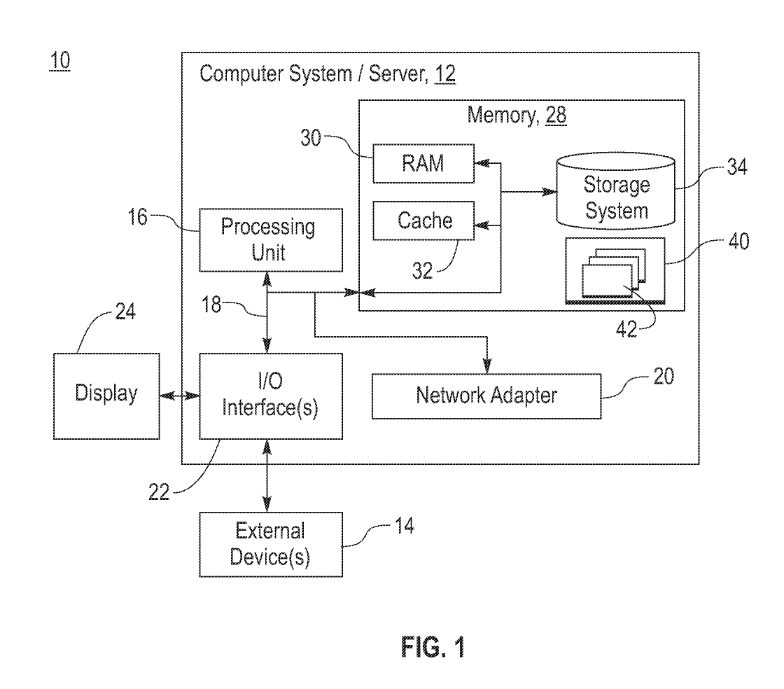

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media, including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components, including system memory 28 to processing units 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

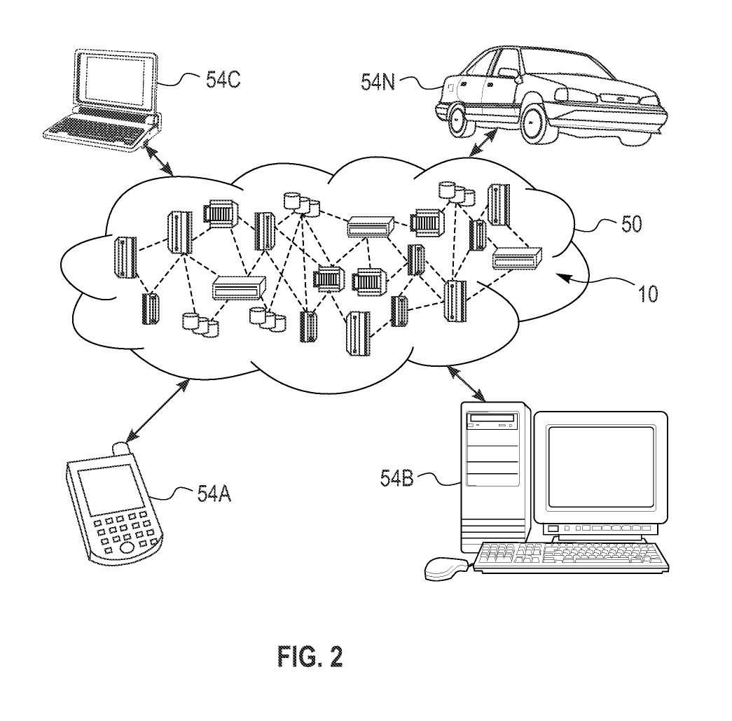

Referring now to FIG. 2, illustrative cloud computing environment 50 is depicted. As shown, cloud computing environment 50 comprises one or more cloud computing nodes 10, with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms, and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

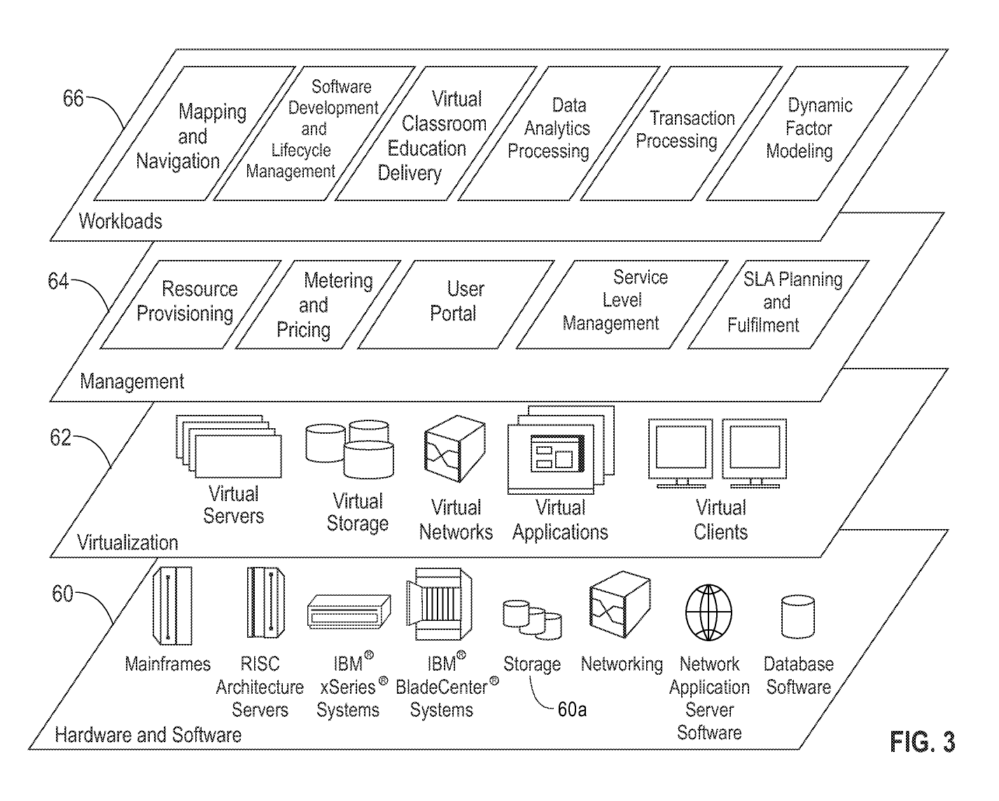

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and dynamic function modeling as will be discussed in detail, below, in the following sub-sections of this Detailed description section. The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

### II. Example Embodiment

A use case is presented here to provide a better understanding to the reader of how some embodiments of the present invention may be used. Stock traders who have a portfolio of bonds, fixed income futures or options, are oftentimes interested in risk management. One embodiment of the invention is a tool where traders enter their holdings and the time horizon. Some embodiments of the present invention provide yield curve forecasts for the next few weeks/months, risk forecasts for their portfolio based on these forecasts, and recommendations to buy/sell bonds to decrease the risk of the portfolio.

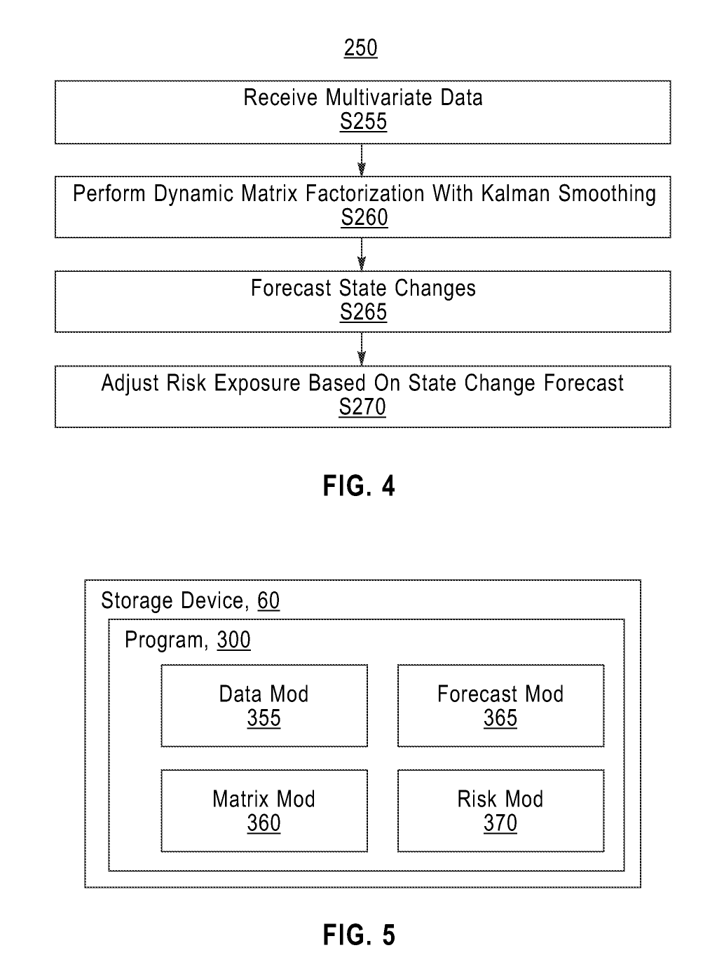

FIG. 4 shows flowchart 250 depicting a method according to the present invention. FIG. 5 shows program 300 within storage 60 for performing at least some of the method steps of flowchart 250. This method and associated software will now be discussed, over the course of the following paragraphs, with extensive reference to FIG. 4 (for the method step blocks) and FIG. 5 (for the software blocks).

Processing begins at step S255, where data module (“mod”) 355 receives multivariate data. Multivariate data is made up of two or more variable values for each sampling unit. For example, a collection of information on the weight (w), height (h), and shoe size (s) from each of a random sample of individuals would include the data triples (w₁, h₁, s₁), (w₂, h₂, s₂), and so forth as a set of multivariate data. As will be discussed in more detail below, financial data sets are often made up of multivariate data. Multivariate financial data sets are used as input for yield curves.

Processing proceeds to step S260, where matrix mod 360 performs dynamic matrix factorization with Kalman smoothing. Generally, factor analysis is used to uncover the latent structure (dimensions) of a set of variables. It reduces attribute space from a larger number of variables to a smaller number of factors. The matrix factorization performed in this step is a form of “enhanced matrix factorization” discussed in more detail below. In this embodiment, Kalman smoothing operations are parallelized in the cloud computing environment (FIG. 3). Alternatively, Kalman smoothing operations are performed on a stand-alone laptop (not shown). Alternatively, Kalman smoothing is performed on a computer sub-system of a networked computer system (not shown).

Processing proceeds to step S265, where forecast mod 365 forecasts state changes. In this example, forecasting is a two-step process: (i) nonparametrically estimate a dynamic matrix factorization of financial data to track its changes over time; and (ii) forecast financial data using the estimated dynamic matrix factorization. A detailed discussion follows that presents ways in which the factorization is estimated. For example, with respect to FIG. 7, state evolution models are trained to estimate the state given a measurement value according to a measurement model.

Processing ends at step S270, where risk mod 370 adjusts risk exposure based on a state change forecast generated in step S265. Risk adjustment will generally be determined by the application of business judgment. Some embodiments of the present invention apply a predetermined risk-based adjustment according to a certain predicted yield curve change. For example, if a steepening yield curve is predicted, indicating that the difference between the yields available for longer dated bonds and shorted dated bonds is widening, a pre-determined risk adjustment is made in anticipation of an approaching period of higher inflation.

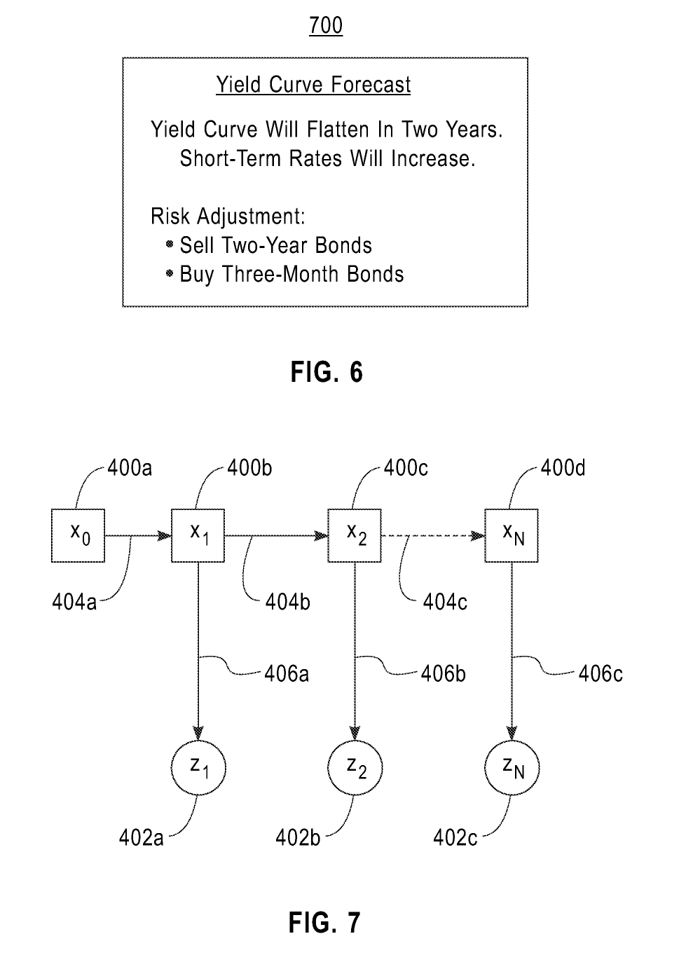

FIG. 6 is a screenshot illustrating risk exposure adjustment according to some embodiments of the present invention. Screenshot 700 is produced by risk module 370 based on the forecasted state change of the yield curve for US Treasury bonds. The forecast is that the yield curve will flatten in two years as a result of the short-term rates increasing with respect to the longer term rates. Accordingly, in this example, the risk module proposes the sale of two-year bonds and the purchase of shorter term 3-year bonds. Alternatively, the risk module deploys a process to sell the longer term bonds automatically when the yield curve is forecasted to flatten.

### III. Further Comments and/or Embodiments

Some embodiments of the present invention recognize the following facts, potential problems and/or potential areas for improvement with respect to the current state of the art: (i) matrix factorization can be enhanced to develop a nonparametric tracking and forecasting algorithm, based on Kalman smoothing, that applies a state space model to both (a) factor loading, and (b) factor time series in the matrix factorization; (ii) principal component analysis (PCA) is one way to extract factors from historical data for risk analysis; (iii) PCA models for yield curves tend to have a very intuitive interpretation; (iv) the top three factors for yield curve changes are: (a) parallel level-shift, (b) slope change, and (c) curvature change; (v) a state space representation provides a convenient and compact way to model and analyze systems with multiple inputs and outputs, such as yield curves; (vi) current factor-based methods for tracking changes in multivariate financial data are limited by required stationarity assumptions on some of the factors; (vii) in multivariate data, such as financial data, there is a need to better track the evolution of the data; (viii) in collaborative filtering, there is a need to better track the evolution of the data (ix) while it is acknowledged that preferences can change over time, methods that track these changes need to better track the evolution of the data; (x) it is desireable to model, track, and/or forecast the changes to the yield curve over time; and/or (xi) the state space representation is amendable to Kalman filtering.

Some embodiments of the present invention provide a state space representation in terms of a time series of factors that allows a non-linear Kalman smoothing methodology to be applied to the problem of tracking evolving multivariate time series data. A matrix of multivariate data is represented as an outer product of two factors. The factors are tracked using a dynamic state space model. Using the state space representation, observed data is obtained using a nonlinear measurement model that predicts data by forming the outer product.

Some embodiments of the present invention manage financial risk by taking the following steps: (i) receive financial data as input; (ii) use dynamic matrix factorization with Kalman smoothing to train a tracking model with financial data; (iii) apply trained tracking model to forecast a corresponding yield curve; and (iv) use the forecast for risk management.

Some embodiments of the present invention operate in a cloud computing environment. It should be noted that, in a cloud computing environment, Kalman smoothing operations may be parallelized, providing an advantage over embodiments practiced on a laptop, or other computer device.

For some embodiments of the present invention, both the factor loading and the factor time series are jointly evolving over each time frame. Inference is performed for both the factor loading and factor time series simultaneously. A nonlinear smoother is provided below to address the fact that both matrix factors evolve over time. For example, modeling financial phenomena and producing an accurate financial forecast require that both matrix factors evolve dynamically.

One example of a dynamic state model for both factor loadings and factor time series in multivariate data is formulated as follows:

$${x}_{k} = [ \begin{matrix}{A}_{k} \\ {F}_{k}\end{matrix} ] ; {x}_{k + 1} = {x}_{k} + {w}_{k} ,$$

where: xₖ is the state at instance k; Aₖ is the factor loading at instance k; Fₖ is the factor time series at instance k; and w is transition process noise.

In this example, the structure is captured by a nonlinear measurement model as follows:

zₖ=hₖ(xₖ)+vₓ;hₖ(xₖ)=(Aₖ^{T}),

where: zₖ is measurement at instance k; hₖ is the measurement model; vₓ is measurement noise; M is the linear measurement operator; and T is the transpose operator.

FIG. 6 is a diagram showing the evolution of states 400a, 400b, 400c, 400d in light of measurements 402a, 402b, 402c, where gradients 404a, 404b, 404c and measurements 406a, 406b, 406c. The measurement model is a composition of a linear measurement operation (mask) M, with the outer product of A, F. The dynamic system is amenable to Kalman smoothing. The goal, in this example, is to obtain estimates on states {xₖ} given measurements {zₖ} with the state evolution model:

xₖ=gₖ(xₖ₋₁)+wₖ,

where: gₖ is gradient at instance k,
and the measurement model:

zₖ=hₖ(xₖ)+vₖ.

Initialization is stated as follows:

x₁=x₀+w₁,

where: x₀ is initial state; x₁.is state at instance 1; and w₁ is transition process noise at instance 1.

The measurement model, at any given instance, may be written as follows:

z=h(x)+v.

The choice of model for noises, wₖ and vₖ, yields the following optimization formulation:

ρ_{w}(w)+ρᵥ(h(x)−z),

where x is minimized,
and where ρ_{w} is the process component; and ρᵥ is the measurement component.

The following use case addresses the need for tracking sudden changes in the yield curve that are unexplained by the dynamic model of choice. That is, the objective in the following use case is to obtain good results in the face of large measurement errors, and/or artifacts in the data. In this example, the statistical models are changed for wₖ and vₖ. The resulting objective is then optimized.

Modeling process errors using non-Gaussian densities allows for better tracking of sudden changes. The following illustrates the use of Student's t-penalty to track sudden changes. The general objective is formulated as follows for dynamic systems:

ρ_{w}(w)+ρᵥ(h(x)−z)+ρᵣ(φ(x)),

where: ρᵣ is the regularization component; and φ is the regularization transformation.

Interest curves should be smooth for dynamic factor models in the finance domain, so the following regularization may be encoded into the formula:

φₖ(xₖ)=D(Fₖ),

where D penalizes curvature of each component across the time window.

Alternatively, a matrix-free approach may be taken. This alternative approach employs the chain rule as follows:

∇Aₖ[ρ(z−M(AₖFₖ^{T}))]=M*∇ρ(r)(Fₖ [symbol] I),

where r=(z−M(AₖFₖ^{T})),

and where: ρ is the measurement component.

Computing this product given ∇ρ(r) has identical complexity as computing the derivative with respect to Fₖ. A positive aspect of this case is that gradient-based methods, such as limited-memory broyden-fletcher-goldfarb-shanno (L-BFGS), may be used with moderate complexity per iteration.

Some embodiments of the present invention may include one, or more, of the following features, characteristics and/or advantages: (i) a fundamentally new factor-based formulation for tracking multivariate data; (ii) represent a matrix of data as an outer product of two factors; (iii) track the two factors making up the matrix using a state space model; (iv) obtain observed data using a nonlinear measurement model which predicts data from forming the outer product; (v) nonparametrically estimate a dynamic matrix factorization of financial data to track its changes over time; (vi) forecast financial data using the estimated dynamic matrix factorization; (vii) manages yield curve risk with nonparametric matrix factorization-based tracking and forecasting; (viii) enables robust, smooth tracking of financial data in which both (a) factor time series, and (b) factor loadings evolve over time; (ix) allows for robust yield curve risk management by forecasting the yield curve change with a trained tracking model; (x) tracks changes in yield curves; and/or (xi) robustly forecasts changes in yield curves.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A method for financial forecasting, the method comprising:
receiving a set of financial data including a first yield curve;
applying dynamic matrix factorization with Kalman filtering;
learning a model for characterizing the set of financial data;
forecasting a first change to the first yield curve based on the model; and
reporting a risk exposure adjustment based, at least in part, on the forecasted first change to the first yield curve.

2. The method of claim 1, wherein:
the first yield curve is a multivariate data set;
the application of dynamic matrix factorization with Kalman filtering includes application of a non-linear Kalman smoothing operation(s) for a plurality of evolving factors, the plurality of factors including: a factor loading, and a factor time series; and
the model is a trained state model.

3. The method of claim 2, wherein the non-linear Kalman smoothing operation(s) are parallelized in a cloud computing environment.

4. The method of claim 2, wherein the plurality of evolving factors evolve simultaneously.

5. The method of claim 1, wherein the first change to the first yield curve is one of a parallel level-shift, a slope change, and a curvature change.

6. A computer program product for financial forecasting, the computer program product comprising a computer readable storage medium having stored thereon:
first program instructions programmed to receive a set of financial data including a first yield curve;
second program instructions programmed to apply dynamic matrix factorization with Kalman filtering;
third program instructions programmed to learn a model for characterizing the set of financial data;
fourth program instructions programmed to forecast a first change to the first yield curve based on the model; and
fifth program instructions to report a risk exposure adjustment based, at least in part, on the forecasted first change to the first yield curve.

7. The computer program product of claim 6, wherein:
the first yield curve is a multivariate data set;
the second program instructions to apply dynamic matrix factorization with Kalman filtering includes application of a non-linear Kalman smoothing operation(s) for a plurality of evolving factors, the plurality of factors including: a factor loading, and a factor time series; and
the model is a trained state model.

8. The computer program product of claim 7, wherein the non-linear Kalman smoothing operation(s) are parallelized in a cloud computing environment.

9. The computer program product of claim 7, wherein the plurality of evolving factors evolve simultaneously.

10. The computer program product of claim 6, wherein the first change to the first yield curve is one of a parallel level-shift, a slope change, and a curvature change.

11. A computer system for financial forecasting, the computer system comprising:
a processor(s) set; and
a computer readable storage medium;
wherein:
the processor set is structured, located, connected, and/or programmed to run program instructions stored on the computer readable storage medium; and
the program instructions include:
first program instructions programmed to receive a set of financial data including a first yield curve;
second program instructions programmed to apply dynamic matrix factorization with Kalman filtering;
third program instructions programmed to learn a model for characterizing the set of financial data;
fourth program instructions programmed to forecast a first change to the first yield curve based on the model; and
fifth program instructions to report a risk exposure adjustment based, at least in part, on the forecasted first change to the first yield curve.

12. The computer system of claim 11, wherein:
the first yield curve is a multivariate data set;
the second program instructions to apply dynamic matrix factorization with Kalman filtering includes application of a non-linear Kalman smoothing operation(s) for a plurality of evolving factors, the plurality of factors including: a factor loading, and a factor time series; and
the model is a trained state model.

13. The computer system of claim 12, wherein the non-linear Kalman smoothing operation(s) are parallelized in a cloud computing environment.

14. The computer system of claim 12, wherein the plurality of evolving factors evolve simultaneously.

15. The computer system of claim 11, wherein the first change to the first yield curve is one of a parallel level-shift, a slope change, and a curvature change.
